(19) United States
(12) Patent Application Publication
(10) Pub. No.: US 2024/0382011 A1
(43) Pub. Date: Nov. 21, 2024

(54) RECYCLABLE MATTRESS AND METHOD OF MANUFACTURE

(71) Applicant: HS PRODUCTS LTD, Leeds West Yorkshire (GB)

(72) Inventors: David GOODLAD, Leeds, West Yorkshire (GB); Nicholas BOOTH, Leeds West Yorkshire (GB)

(21) Appl. No.: 18/693,717

(22) PCT Filed: Sep. 21, 2022
(86) PCT No.: PCT/GB2022/052384

§ 371 Date: Mar. 20, 2024

(30) Foreign Application Priority Data
Sep. 21, 2021 (GB) 2113434.1
Dec. 16, 2021 (GB) 2118241.5
Jun. 13, 2022 (GB) 2208647.4

(51) Int. Cl. A47C 27/06; A47C 27/05; A47C 31/10

(52) U.S. Cl. CPC A47C 27/064; A47C 27/05; A47C 31/105

(57) ABSTRACT

A resilient unit 2400 is made up of modules 2400A-2400E, each comprising a central core of pocketed springs and a peripheral frame comprising one or more pads or blocks of recyclable polymeric material.

Intermediate modules 2400C, 2400D and 2400E are provided between base module 2400A and upper module 2400B.

The intermediate modules can be selected and combined to provide a mattress with very specific characteristics, in accordance with a user's requirements.

The present invention relates to a recyclable mattress and to a method of manufacturing a recyclable mattress.

Several types of existing mattress are difficult to recycle either because of the method by which they were constructed or else because of the materials that were used during manufacture. Even examples that are partially recyclable are not especially attractive to recyclers from a commercial perspective, either because of the costly processes needed due to the number of different materials used in the mattress, or else for other reasons such as the poor yield of semi-valuable components.

Other problems with many existing types of mattress arise from the use of flame retardant chemicals in their manufacture. These substances pose a threat to human health.

Embodiments of the present invention aim to provide a recyclable resilient unit, in which at least some of the aforementioned problems are addressed.

The present invention is defined in the attached independent claims, to which reference should now be made. Further, preferred features may be found in the sub-claims appended thereto.

According to one aspect of the present invention, there is provided a resilient unit comprising a central core of pocketed springs and a peripheral frame comprising one or more pads or blocks of recyclable polymeric material.

The peripheral frame may comprise one or more side blocks of recyclable polymeric material and/or one or more end blocks of recyclable polymeric material.

At least one side block may be arranged to connect with at least one end block.

The resilient unit may comprise a top panel of recyclable polymeric material. The resilient unit may comprise a base pad of recyclable polymeric material.

In a preferred arrangement, the central core is substantially enclosed by the or each side block, the or each end block, the top pad and the base pad.

The resilient unit is preferably rectangular in plan shape and/or generally cuboid in shape.

The resilient unit may comprise a mattress for a bed or similar.

One or more of the side blocks and/or the end blocks may include a ventilation channel to allow air into the central core.

The recyclable polymeric material may comprise crimped fibres, still more preferably conjugate fibres. The recyclable polymeric material may comprise polyester.

Alternatively, or additionally, the recyclable polymeric material may comprise polypropylene.

In a preferred arrangement, at least some of the blocks and/or pads may be joined together by connector elements. The connector elements may comprise rings of metal.

Alternatively, or in addition, one or more of the blocks and/or pads may be thermally bonded to one or more others of the block(s)/pad(s).

The central core may comprise one or more pocketed spring units. Preferably, the central core comprises at least two superposed pocketed spring units. A lower pocketed spring unit may comprise springs which are taller than they are wide (in their pockets). An upper pocketed spring unit may comprise springs that are wider than they are tall (in their pockets). At least two upper spring units may be superposed over the lower spring unit.

In a preferred arrangement, one or more components of the resilient unit are connected together by one or more barbed tags passing through the resilient unit. In a preferred arrangement, the barbed tags pass through at least the core portion of the unit and more preferably are arranged to secure together two or more of the pocketed spring units.

The resilient unit may comprise a cover arranged to extend over at least a part of the core and optionally at least partly over one or more side and/or end blocks. The cover is preferably removable and may include a closure device for closing the cover. The closure device may comprise a zip, which is preferably of recyclable material, such as polyester.

The cover may comprise a substantially continuous array of pocketed springs arranged in use to extend substantially over at least one major surface of the resilient unit. The cover springs may comprise a pocketed spring unit. Optionally the pocketed spring unit may be located, preferably removably, within a pocket or sleeve of the cover.

The cover may be arranged to extend substantially over a resilient unit according to any statement herein.

Preferably, the unit comprises only the springs, the pocketing material, the blocks and pads and connector elements, and optionally the cover. Accordingly, the unit may be fully recycled at the end of its life.

The resilient unit may comprise a plurality of modules, each comprising a pocketed spring unit and a peripheral frame of blocks, optionally with one or more pads above and/or below.

The modules may be joined together, one above the other, using connectors, such as zips.

The modules may be interchangeable to provide a customised resilient unit/mattress. For example, the resilient unit may comprise a base module, an upper module and, optionally one or more intermediate modules.

The resilient unit may include a removable module that covers at least one other module and connects to a further module, preferably by a zipper.

The resilient unit may comprise a structural base portion for supporting the resilient unit. The structural base portion may comprise a rigid frame, optionally of wood.

According to another aspect of the present invention, there is provided a method making a resilient unit, the method comprising surrounding/enclosing a central core of pocketed springs within a peripheral frame comprising one or more pads or blocks of recyclable polymeric material.

The method may comprise joining at least some of the pads and/or blocks together with connector elements. The connector elements may comprise rings of metal.

Alternatively, or in addition, at least some of the blocks and/or pads may be joined by heating a surface of the block/pad and/or heating a surface of an adjacent block/pad and applying pressure to the blocks/pads to urge them together. The heat is preferably provided by directing heated air onto the surface(s). In a preferred arrangement, heated air is directed onto the surface(s) of the block(s)/pad(s) by a heating tool that is moved along the surface immediately prior to the block(s)/pad(s) being urged together.

In a preferred arrangement, the method comprises connecting together one or more components of the resilient unit by passing one or more barbed tags through them. More preferably, the method may comprise connecting together two or more pocketed spring units in the core using the barbed tags.

The invention may include any combination of the features or limitations referred to herein, except such a combination of features as are mutually exclusive, or mutually inconsistent.

A preferred embodiment of the present invention will now be described, by way of example only, with reference to the accompanying diagrammatic drawings, in which:

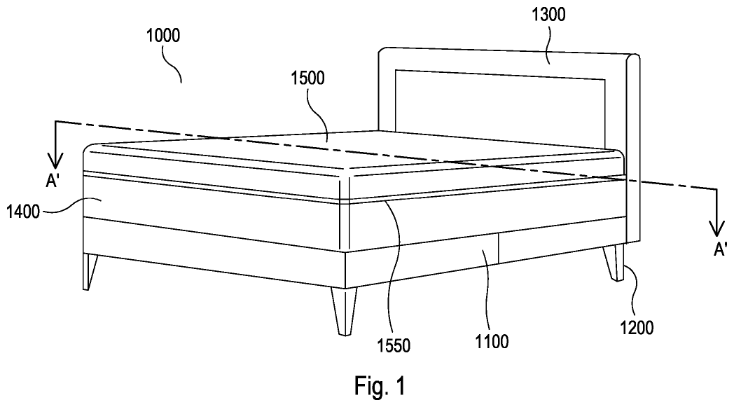

FIG. 1 shows schematically a bed including a resilient unit according to an embodiment of the present invention;

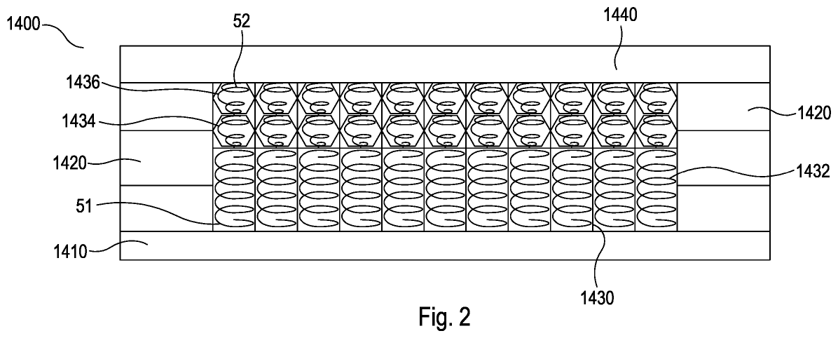

FIG. 2 shows schematically a section of the resilient unit, taken through lines A-A′ of FIG. 1;

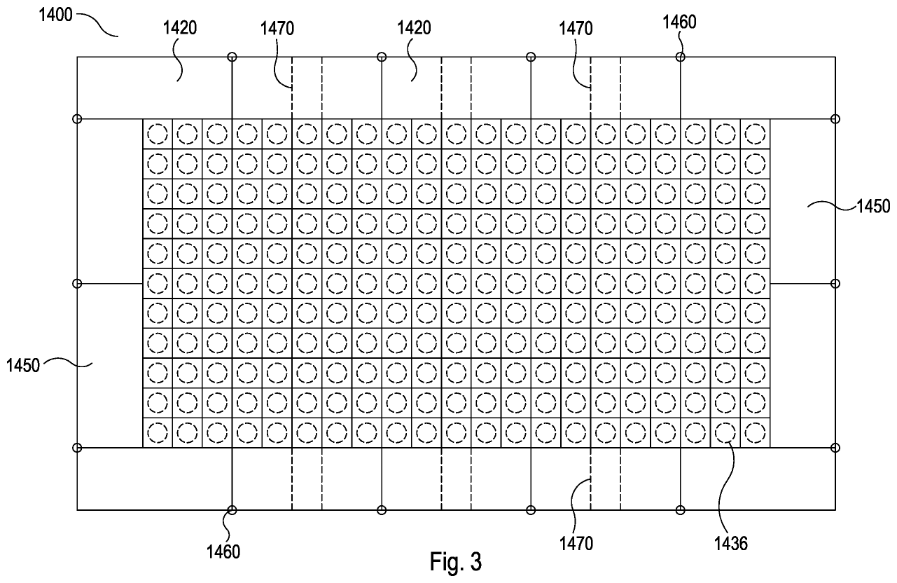

FIG. 3 shows schematically a plan view of the resilient unit of FIGS. 1 and 2, with a top pad removed to show the interior of the unit;

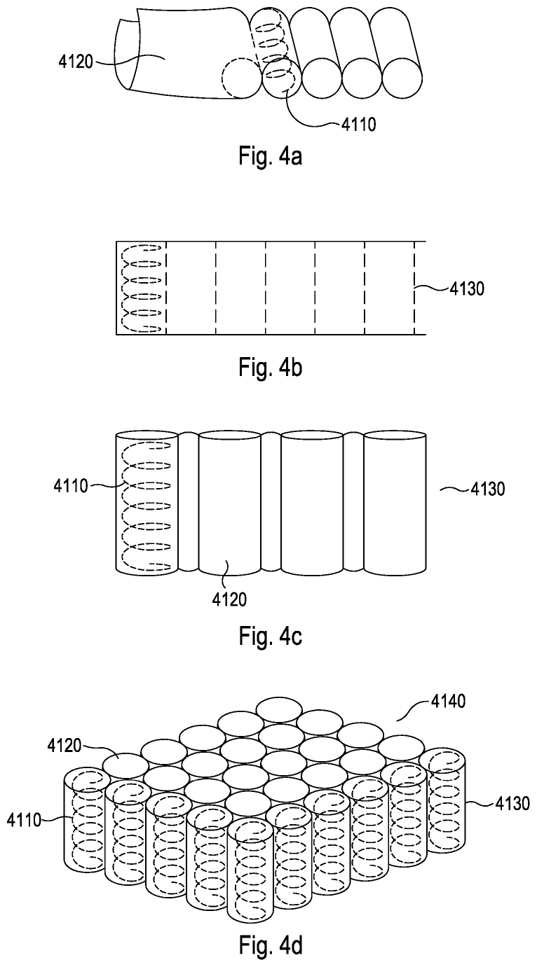

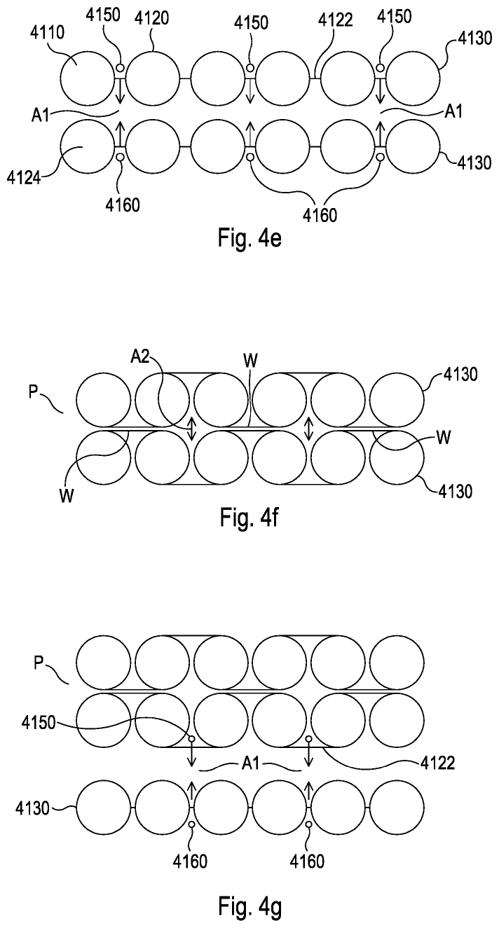

FIGS. 4a to 4g show schematically the stages in production of a pocketed spring unit that is incorporated into the resilient unit of FIGS. 1-3;

FIG. 5 shows schematically a cover for the resilient unit of FIGS. 1-3;

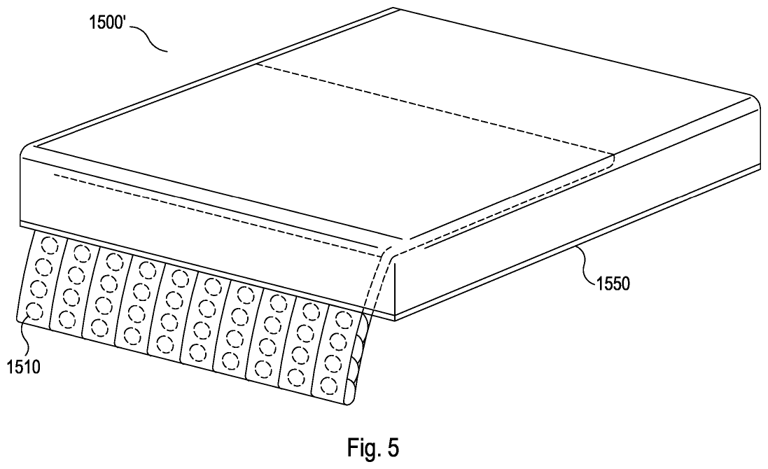

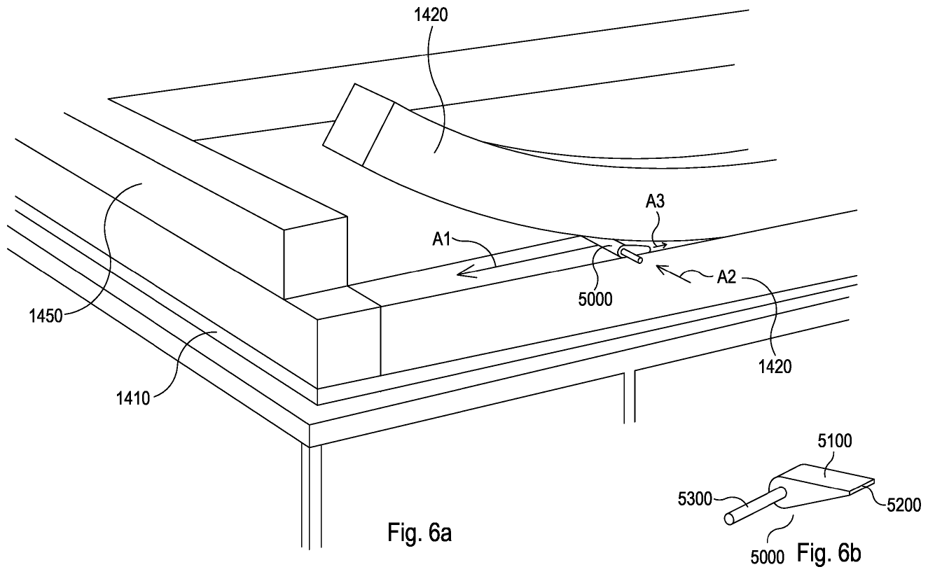

FIGS. 6a and 6b show schematically an alternative method of joining the blocks;

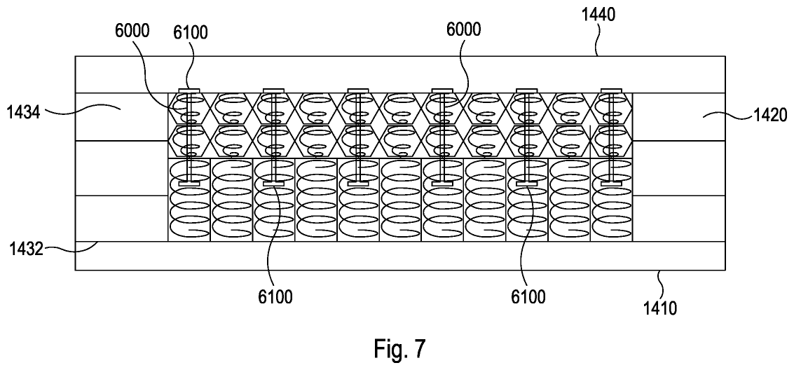

FIG. 7 shows schematically in section an alternative embodiment of resilient unit;

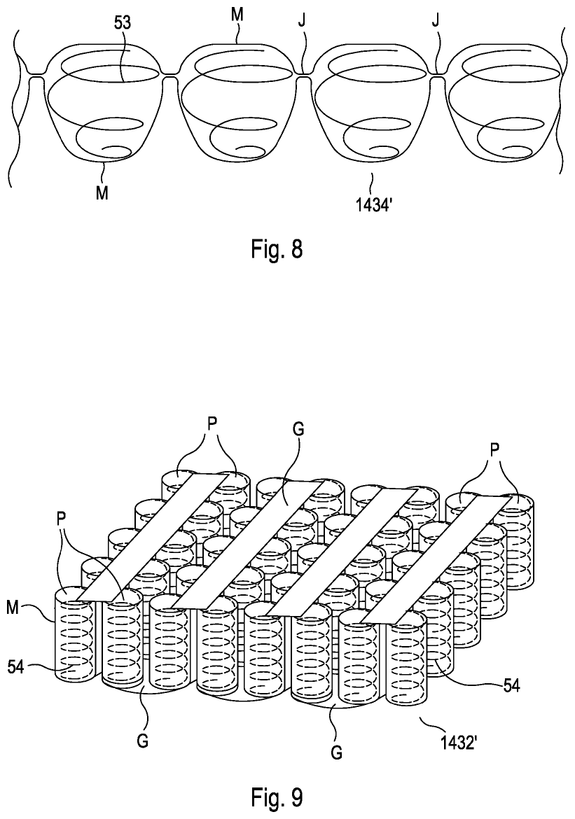

FIG. 8 shows an alternative embodiment of a second pocketed spring unit;

FIG. 9 shows an alternative embodiment of a first pocketed spring unit;

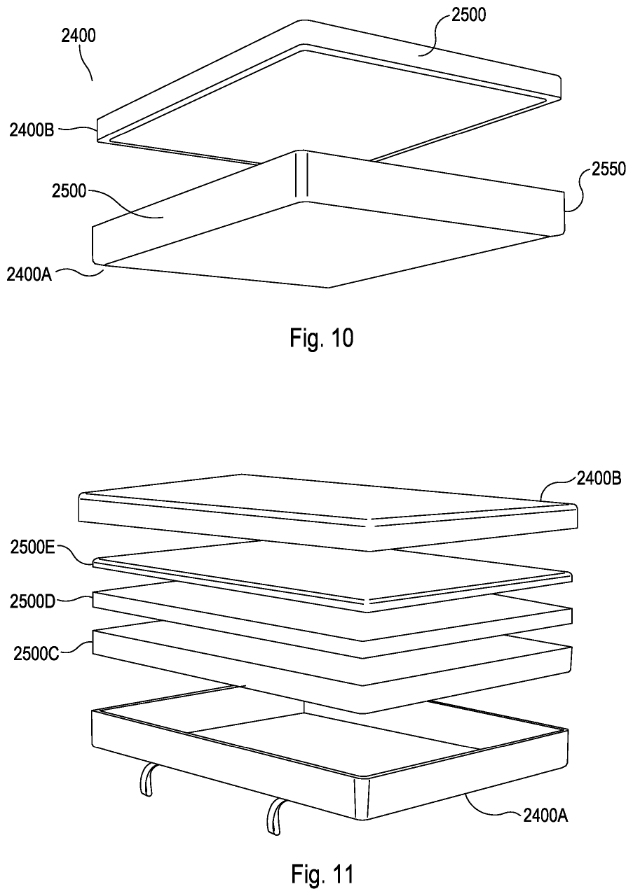

FIG. 10 shows schematically an alternative embodiment of resilient unit;

FIG. 11 shows schematically a further alternative embodiment of resilient unit;

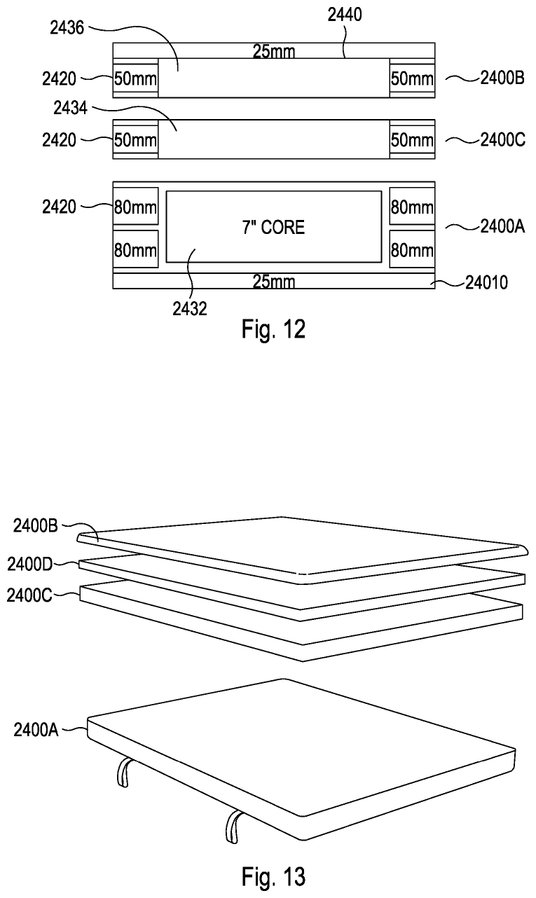

FIG. 12 shows a schematic, sectional, exploded view of the embodiment of FIG. 11;

FIG. 13 shows in schematic exploded a still further embodiment of resilient unit;

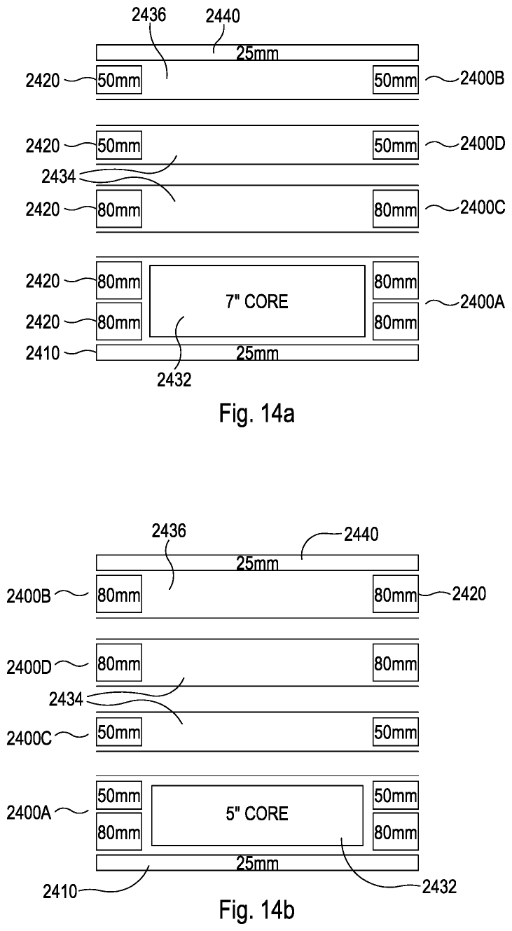

FIGS. 14(a) and 14(b) show in schematic, sectional, exploded view variants of the resilient unit of FIG. 13;

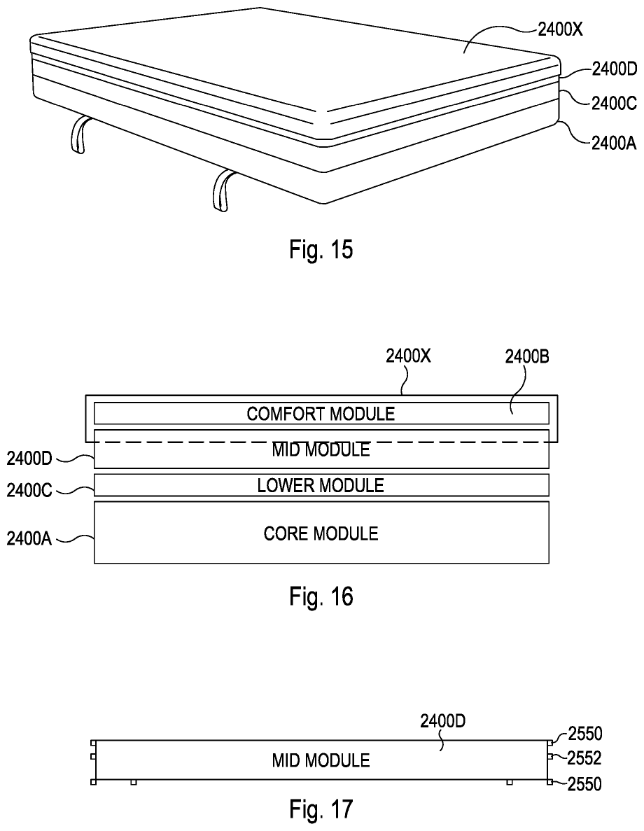

FIG. 15 shows a still further embodiment of resilient unit;

FIG. 16 shows in schematic, sectional, exploded view the resilient unit of FIG. 15;

FIG. 17 shows in schematic end view a module of the unit of FIGS. 15 and 16;

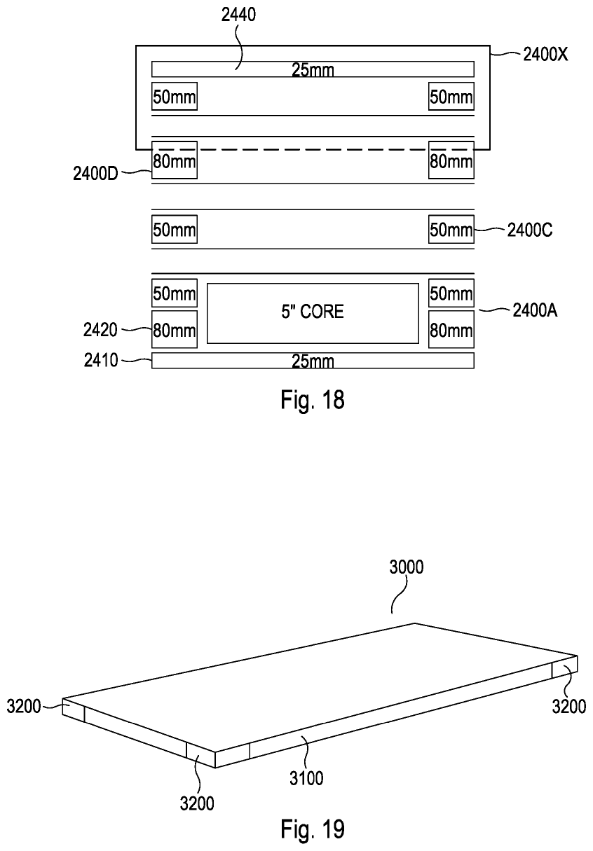

FIG. 18 shows in schematic, sectional, exploded view a variant of the unit of FIGS. 15-17;

FIG. 19 shows a part of an optional variant of a resilient unit in accordance with the present invention;

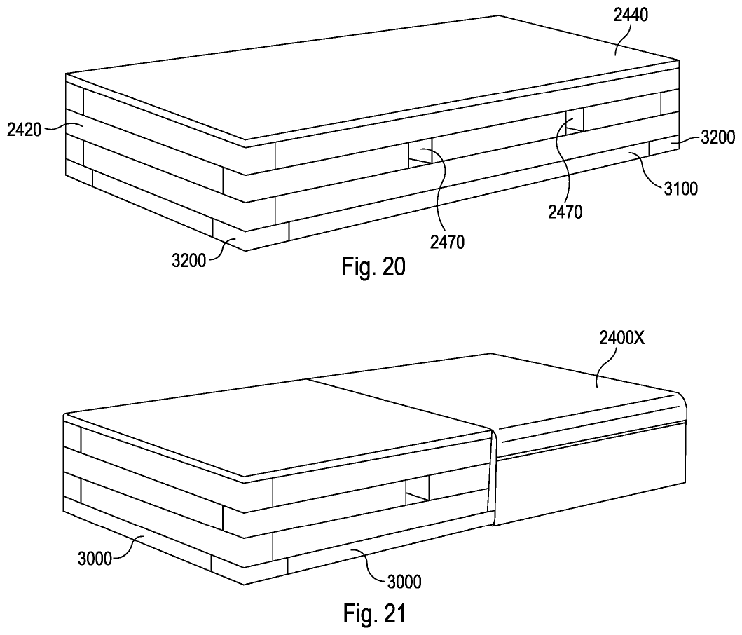

FIG. 20 shows the unit of FIG. 19 with further components included; and

FIG. 21 shows the unit of FIGS. 19 and 20 with a cover and in partial cutaway view.

Turning to FIG. 1, this shows generally at 1000 a bed, comprising a base 1100, with attached legs 1200, a headboard 1300 and a resilient unit 1400 as a mattress on the base. A removable cover 1500 partly encloses an upper portion of the mattress and is attached thereto by a zipper 1550.

The resilient unit will be described below with reference to FIGS. 2 and 3.

FIG. 2 is a schematic section of the resilient unit alone, taken along line A-A′ of FIG. 1. The unit 1400 comprises a base pad 1410 and sidewalls formed of blocks 1420. Resting on the base pad, between the side walls is a pocketed spring core 1430, comprising a first pocketed spring unit 1432 on which rests a second pocketed spring unit 1434 and above that a third pocketed spring unit 1436. An upper pad 1440 lies over the pocketed spring units and the tops of the sidewall blocks 1420.

The first pocketed spring unit 1432 is preferably of tall steel coil springs which are individually encased in pockets formed by overlying webs of pocketing material that are joined at their edges and at positions between the springs by ultrasonic welds. The springs are thus formed into linear strings which are then joined together by ultrasonic welds to form an array. An example of the structure of the unit 1432 will be described later with reference to FIG. 4.

The second and third pocketed spring units 1434 and 1436 comprise shorter steel coil springs, that are held under partial compression within pockets formed by axially superposed sheets of pocketing material that are joined at their edges and at positions between the springs by ultrasonic welds. An example of such a unit may be found in our European Patent Number EP 2672862.

The box-like frame of blocks and pads enclosing the core is completed by end walls comprising further blocks. These are not shown in FIG. 2 by may be seen in FIG. 3.

Turning to FIG. 3, this shows schematically the unit 1400 in plan view. The top pad 1440 has been removed in the interests of clarity. End walls are comprised of blocks 1450 and the blocks 1420 and 1450 are joined together and to one another by metal ring fasteners 1460, known in the industry as “hog rings”. Further rings may be used to connect together the core units 1432, 1434 and 1436.

Some of the blocks 1420 are provided with ventilation channels 1470 which extend from the inner core units to the exterior to allow air to circulate throughout the mattress so as to keep it cool and fresh, and to avoid the build up of condensation.

The blocks 1420, 1450 and pads 1410 and 1440 are made of a recyclable fibrous plastics material which is preferably polyester. The material is a blend of coarse and fine fibres including a spiral crimped conjugate fibre which provides a spring-like characteristic to the final pad, and an elastomeric binder fibre. The material may be made of recycled materials and in particular of plastics recovered from the sea and it is fully recyclable at the end of life.

The pocketing material comprises spun-bonded polyester which is also recyclable, as is the steel used to make the springs and the hog ring fasteners.

The cover 1500 (FIG. 1) may also be of recycled (and recyclable) polyester material and may be detached from the unit 1400 by the zipper 1550, which connects the two at approximately one third of the depth of the unit 1400.

FIGS. 4a to 4g show schematically steps in forming a pocketed spring unit such as can be used as the first unit 1432. Referring to FIG. 4a, the springs 4110 are initially placed between sheets or plies of pocketing material, which could be a single sheet 4120 folded into two. The sheets are then welded along their edges and between the springs to encase the springs in individual pockets. FIGS. 4b and 4c are respective schematic side and perspective views of a so-called “string” 4130 of springs formed in this way.

The strings 4130 are then joined together to form an array 4140 as shown in FIG. 4d. Such an array, of an appropriate length and width, is used in a mattress core.

Turning to FIG. 4e, this shows two single strings 4130 of pocketed springs, each comprising a linear array of metal, e.g. steel, coil springs 4110 encased in individual pockets formed by sheets 4120 of weldable pocketing material, which may, for example, comprise spun-bonded polymer, e.g. polyester. It should be noted that the strings shown as examples contain only six individual pocketed springs, whereas in reality they would include more than this, depending upon the desired dimensions of the pocketed spring unit being manufactured.

The sheets 4120 (which may comprise a single sheet that has been folded over the springs or may comprise two separate sheets) are joined along their edges (not shown), in this example by ultrasonic welds. The sheets are also joined between the springs 4110, again in this example by ultrasonic welds, to form connection portions 4122, thereby defining individual pockets 4124 for the springs 4110. The connection portions are parts of the sheets, or plies, that have been joined between the springs, in the formation of the pockets. The two strings are aligned in parallel before the next step of the method in which sets of ultrasonic welding tools, comprising sonotrodes (or horns) 4150 and anvils 4160 are brought together to weld alternate ones of the connection portions 4122 together in the direction of Arrows A1, thereby joining the strings 4130.

FIG. 4f shows the two strings after the welding operation. Where the welding has taken place, the connection portions 4122 of the two strings 4130 are joined by ultrasonic welds W. The welds W are located between the strings 4130 and effectively bring four pockets 4124 together. The welding tools 4150 and 4160 have pushed together and joined the connecting portions 4122 of alternate pairs of pocketed springs. In doing so the pockets either side of the weld W have been rotated somewhat, so that the unwelded connecting portions have become pushed outwards in the direction of Arrows A2 and are now present on the outward facing sides of the pair P of strings.

FIG. 4g shows the next step, in which a new string 4130 is placed alongside the joined pair P. The position of the welding tools has been shifted laterally along the strings 4130 by a distance of one spring so that the unwelded connecting portions 4122 of the pair P are aligned for welding with corresponding connecting portions 4122 of new string 4130. Once again, the sets of welding tools 4150, 4160 are brought together and the new string 4130 is joined to the pair P. The result is a partly formed pocketed spring unit 4140.

The process is repeated, each time indexing the unit 4140 and moving the welding tools back and forth, in a reciprocal manner, so as to weld alternate connecting portions to the new string until a sufficient number of strings, or rows, have been added.

The joining of the strings takes place on a supporting surface which may include apparatus (not shown) for gripping and moving the individual strings 4130, and/or for indexing the unit 4140. Both sets of welding tools 4150 and 4160 may be inserted beside the connecting portions 4122 from above and/or below the unit, i.e. in a direction parallel with the axes of the springs themselves, or else at least one of the sets of welding tools, for example 4160, may be introduced in a direction substantially transverse to the axes of the springs, for example in the direction in which the new string is being presented, i.e. transverse to the extent of the string. Whereas the tools 4150 and 4160 are described in this example as, respectively, sonotrodes and anvils, their positions/roles could be reversed.

Indeed, the example of ultrasonic welding apparatus could be replaced by thermal bonding, or heat-sealing tools.

FIG. 5 shows schematically an alternative embodiment of cover 1500′ for the resilient unit 1400 described above. The cover has an internal sleeve/pocket on its major surface in which a pocketed spring unit 1510 can be accommodated. The pocketed spring unit is similar to the ones described above and labelled 1434 and 1436, being comprised of small, relatively flat coil springs located in individual pockets formed by joining sheets/plies of pocketing material at positions between the springs and at the edges of the unit.

The cover 1500′ is shaped to fit over at least the upper major surface of the resilient unit 1400 and to flow substantially continuously over the edges and onto the sides and ends thereof to provide extra comfort to a user of the pad and to further assist in the retention of pad shape and size. A zipper 1550 releasably joins the cover to the mattress unit 1400. The cover can accommodate pocketed spring units with springs of different characteristics and the pocketed spring units can be interchanged to modify the user's experience of the mattress.

Turning to FIGS. 6a and 6b, these show an alternative method of joining the blocks 1420 and 1450 to each other and to the lower pad 1410 and upper pad (not shown), without the need for fasteners, such as the rings 1460.

The method involves heating the adjacent surfaces of the blocks and/or pads to be joined using a heating tool 5000. In the example shown in the drawing, the heating tool passes between adjacent side blocks 1420 immediately before they are joined. The tool 5000 has a hollow, generally wedge-shaped body 5100 defining an outlet slot 5200 an inlet tube 5300. When the tool is moved between adjacent blocks 1420 in the direction of Arrow A1, hot air is blown into the tube in the direction of Arrow A2 which exits the slot 5200 in the direction of Arrow A3. Pressure is applied to the blocks pushing them together immediately behind the moving tool 5000. The effect of the heated air is to temporarily soften the surfaces of the blocks 1420 so that they become bonded together when the pressure is subsequently applied.

Turning to FIG. 7, this shows an optional means of joining the core units 1434 and 1432, for enhanced stability. In this example, tags 6000 are inserted through the pocketed spring units of the core. The tags, which may be of polypropylene material for example, have barbs 6100 at each end so that they are able to hold the pocketed units together without becoming loose. Use of the tags 6000 instead of other types of fasteners makes disassembly of the mattress easier at the end of its life.

FIG. 8 shows an alternative to the second pocketed spring units 1434 and 1436 above. Again, the springs are typically wider than they are tall but, in this embodiment, the coils at opposed axial ends of the springs may be of different diameters. Where this is so, the joins in the plies of pocketing material preferably are axially closer to, but not at, the ends of the springs having the coils of larger diameter.

FIG. 9 shows an alternative to the first, or main, pocketed spring unit of the core 1432. In this embodiment the pad comprises a number of springs 120 of coiled metallic wire (shown in broken lines) encased in individual pockets, one spring to a pocket in the example shown, formed between superposed sheets 140 or layers of material joined at positions P between the springs, preferably by welding. The sheets 140 are joined at least at two spaced apart positions P between each pair of adjacent springs 120, so that a gusset 160, or pleat, is formed between each pair of springs.

An example of an apparatus and a method for making the pad shown in FIG. 9 can be seen in our UK Patent No. GB2547336 B1, the entire contents of which are incorporated herein by reference.

After encapsulation, the springs S4 are turned within their pockets, so that their axes extend longitudinally, between the weld points P. Turning the springs within their pockets is achieved readily, particularly with tall springs, as they have a tendency to turn in any case and need only be urged to do so, for example by vibrating the pad, or else by utilising a lip or ridge to catch an upper leading edge of the spring, or a lower trailing edge, thereby causing it to flip.

The pad is then folded, or pleated, in the manner of a fan, concertina or accordion, so that alternate adjacent pocketed springs are made to extend first one way, and then the other way, to form the resilient unit shown in FIG. 9. During folding, the gussets act as hinges between rows of springs. When the unit has been folded in this way, the axes of substantially all of the springs S4 become aligned in a direction that is generally transverse to the longitudinal extent of the unit.

In one embodiment not shown, in the unfolded pad adjacent rows of springs are offset from one another in a direction across the pad, transverse to the axes of the springs, so that when the pad is folded the springs nest, each between two adjacent springs of a neighbouring row. This provides for a more stable pad.

The springs can be chosen for their characteristics such as stiffness and size and, as well as controlling the stacking of different springs, the springs can be grouped into zones along the extent of the unit and combined in such a way as to provide specifically desired performance characteristics. These characteristics can be determined by the intended use of the resilient unit.

Mattress units according to the present invention are fully recyclable at the end of life. In particular, they are free of foam and glue, neither of which is recyclable. Also, because the materials from which they are made are inherently flame retardant, there is no need to use potentially harmful chemical fire retardant treatments in their manufacture.

Turning to FIG. 10, this shows schematically at 2400 an alternative embodiment of resilient unit, forming, for example, a mattress. In this embodiment, the resilient unit is made up of self-contained, separable base and upper modules 2400A and 2400B. Each module comprises a pocketed spring unit enclosed peripherally by blocks along its sides and ends, and optionally by upper and lower pads, as in the embodiment of FIGS. 2 and 3 above, and encased in a cover. The blocks and pads are of recyclable polymeric material, which may be the same material as in earlier described embodiments, and are not shown in the drawing. The pocketed spring units may comprise one or more units as described above. Typically, the base module contains a core unit of taller springs, such as of the type referenced in the earlier embodiment as 1432. The upper module may include one or more pocketed spring units of the type referenced in the earlier embodiment as 1434 and 1436. Each module has a cover 2500 and the two modules are connectable, for example by a zipper 2550. Optionally, one or both of the pads (1410, 1440 in the FIG. 2 embodiment) may be omitted. For example, one of the lower pad on the upper module and the upper pad on the base module may be replaced by sheet of pocketing material, there being no need to have two pads between the pocketed spring units.

FIG. 11 shows a further embodiment of resilient unit, generally at 2400, in which additional, intermediate modules 2400C, 2400D and 2400E are provide between the base module 2400A and upper module 2400B. The intermediate modules include pocketed spring units, for example of the kind described earlier in relation to FIG. 2, and referenced as 1434,1436, and peripheral blocks and optionally pads above/below. The base module has a peripheral zipper around its upper edge and the upper module has a peripheral zipper around its lower edge. The intermediate modules have peripheral zippers around their upper and lower edges. By these zippers, the modules may be joined together. An overall cover (not shown) encloses all of the modules.

The intermediate modules can be selected and combined to provide a mattress with very specific characteristics, in accordance with a customer's requirements.

FIG. 12 shows schematically the unit of FIG. 11 in transverse section. Only a single intermediate module 2400C is shown, in the interests of simplicity, but in practice the number of intermediate modules can vary. Inside the base module 2400A is a core of pocketed springs 2432 surrounded by side blocks 2420 with a lower pad 2410 beneath. The upper module 2400B has a pocketed spring unit 2436 surrounded by side blocks 2420 and covered by an upper pad 2440. The intermediate module 2400C has a pocketed spring unit 2434 surrounded by blocks 2420. An overall cover, enclosing all the modules, has been omitted from the diagram.

FIG. 13 shows schematically another embodiment in which, again, a base module 2400A, an upper module 2400B and intermediate modules 2400C and 2400D are connectable by peripheral zippers. This embodiment differs from the previous one in that, when connected, the modules remain visible and distinct, as there is no overall, common cover to enclose them. The modules may have the same type of construction as described above in relation to FIG. 12.

FIGS. 14(a) and 14(b) are schematic, sectional depictions of modular resilient units of different sizes, in accordance with the embodiments of FIGS. 12 and 13.

In FIG. 14(a), the base module 2400A has a core pocketed spring unit 2432 of approximately 178 mm in height, with a frame comprising superposed peripheral blocks 2420 of 80 mm in height and a base pad 2410 beneath. The first intermediate module 2400C has a pocketed spring unit 2434 surrounded by a single course of blocks 2420 of 80 mm in height. The next intermediate module 2400D has a pocketed spring unit 2436 surrounded by blocks of 50 mm height. The upper module 2400B has a pocketed spring unit 2436 surrounded by blocks of 50 mm height and an upper pad 2440.

In FIG. 14(b), the base module 2400A has a thinner core pocketed spring unit 2432 of approximately 127 mm in height, with a frame comprising superposed peripheral blocks 2420 of 80 mm in height (lower course) and 50 mm in height (upper course) and a base pad 2410 beneath. The first intermediate module 2400C has a pocketed spring unit 2434 surrounded by a single course of blocks 2420 of 50 mm in height. The next intermediate module 2400D has a pocketed spring unit 2436 surrounded by blocks of 80 mm height. The upper module 2400B has a pocketed spring unit 2436 surrounded by blocks of 80 mm height and an upper pad 2440.

From this it can be seen that the modules are interchangeable and may be selected to achieve any particular resilience characteristic and height, within limits.

FIG. 15 shows schematically a further embodiment of resilient unit 2400. Again, the structure is made up of base 2400A, upper 2400B and intermediate 2400C, 2400D modules. However, in this embodiment, in addition to the zippers which connect the modules together, a further peripheral zipper 2552 is located on one of the intermediate modules. Unlike zippers 2550, this zipper is located below an upper edge of the intermediate module 2400D and is arranged to connect the module to a removeable sleep surface module 2400X. The sleep surface module 2400X conceals the upper module 2400B, but the rest of the modules remain visible and distinct.

FIGS. 16 and 18 show the unit of FIG. 15 in schematic sectional view, and FIG. 17 shows, schematically, the intermediate module 2400D in more detail.

Turning to FIG. 19, this shows a structural base portion 3000 which can optionally be incorporated into any of the base modules described above. The base portion 3000 comprises a substantially rectangular frame, optionally of wood, having elongate frame members 3100 joined together by corner brackets 3200, optionally of plastics. The portion 3000 may be enclosed in a sheet of recyclable material.

FIG. 20 shows the structural base portion 3000 incorporated into a resilient unit such as described above, for example, with blocks 2420 surrounding pocketed spring units. Ventilation channels 2470 (cf 1470 in the earlier embodiment) can be clearly seen.

FIG. 21 shows schematically the embodiment of FIGS. 15-18 together with the optional base portion 3000, in part cutaway depiction.

A benefit of the structural base portion 3000 is that it may obviate the need for a conventional separate bed base to support the resilient unit. It may also facilitate the use of resilient units according to the present invention in applications where they must be lifted, for example hingedly, to gain access to a storage unit beneath, for example in the manner of an Ottoman-style storage unit.

Embodiments of the present invention are able to provide fully recyclable mattresses. In some embodiments, the resilient units/mattresses are made up of modules that can be replaced, interchanged and/or combined to create characteristics that can be selected by a user. The result can be a mattress that need not be disposed of entirely when one or more components are in need of replacement.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A resilient unit comprising a central core of pocketed springs and a peripheral frame comprising one or more pads or blocks of recyclable polymeric material.

2. A resilient unit according to claim 1, wherein the peripheral frame comprises one or more side blocks of recyclable polymeric material and/or one or more end blocks of recyclable polymeric material.

3. A resilient unit according to claim 2, wherein at least one side block is arranged to connect with at least one end block.

4. A resilient unit according to claim 1, wherein the resilient unit comprises a top panel of recyclable polymeric material.

5. A resilient unit according to claim 1, comprising a base pad of recyclable polymeric material.

6. A resilient unit according to claim 1, wherein the central core is substantially enclosed by one or more side blocks, one or more end blocks, a top pad and a base pad.

7. (canceled)

8. A resilient unit according to claim 2, wherein one or more of the side blocks and/or the end blocks includes a ventilation channel to allow air into the central core.

9. A resilient unit according to claim 1, wherein the recyclable polymeric material comprises fibres, more preferably crimped fibres, still more preferably conjugate fibres.

10. (canceled)

11. A resilient unit according to claim 1, wherein at least some of the blocks are joined together by connector elements.

12. (canceled)

13. (canceled)

14. A resilient unit according to claim 1, comprising a removable cover arranged to extend over at least a part of the core and optionally at least partly over the frame.

15. A resilient unit according to claim 14, wherein the cover comprises a substantially continuous pocketed spring unit arranged in use to extend substantially over at least one major surface of the resilient unit.

16. A resilient unit according to claim 14, wherein the pocketed spring unit is removably located within a pocket or sleeve of the cover.

17. A resilient unit according to claim 1, wherein one or more of the blocks and/or pads is thermally bonded to one or more others of the block(s)/pad(s).

18. A resilient unit according to claim 1, wherein components of the unit are connected together by one or more barbed tags.

19. A method of making a resilient unit, the method comprising enclosing a central core of pocketed springs within a peripheral frame comprising one or more pads or blocks of recyclable polymeric material.

20. A method according to claim 19 comprising joining at least some of the pads and/or blocks together with connector elements.

21. A method according to claim 19, wherein at least some of the blocks and/or pads are joined by heating a surface of the block/pad and/or heating a surface of an adjacent block/pad and applying pressure to the blocks/pads to urge them together.

22. A method according to claim 21, wherein the heat is provided by directing heated air onto the surface(s).

23. A method according to claim 22, wherein heated air is directed onto the surface(s) of the block(s)/pad(s) by a heating tool that is moved along the surface immediately prior to the block(s)/pad(s) being urged together.

24. A method according to claim 19, wherein the method comprises connecting components of the unit by passing one or more barbed tags through at least some pocketed spring units of the core.
